(19) United States
(12) Patent Application Publication
(10) Pub. No.: US 2003/0142174 A1
(43) Pub. Date: Jul. 31, 2003

(54) Baffles to protect inkjet printheads by capturing contaminants, and method

(76) Inventors: Patrick Boyd, Albany, OR (US); Warren S. Martin, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/059,841

(22) Filed: Jan. 28, 2002

(51) Int. Cl. B41J 2/17

(52) U.S. Cl. 347/85; 347/84

(57) ABSTRACT

Baffles located next to the input of the ink feed channel in an inkjet pen to capture and retain contaminant particles before the particles reach the printhead. Particles that may accumulate on interior surfaces of the pen when the pen is maintained in an non-printing orientation are thus prevented from cascading into the ink feed channel when the pen is reoriented for printing.

### FIELD OF THE INVENTION

The present invention relates generally to inkjet printing mechanisms, such as printers or plotters. More particularly, the present invention relates to apparatus and methods for preventing the clogging of inkjet printhead nozzles by contaminants.

### BACKGROUND OF THE INVENTION

Inkjet printing mechanisms are well known in the art and are used in a variety of applications, including plotters, facsimile machines and inkjet printers. Inkjet printing mechanisms use inkjet “pens” to eject drops of ink onto sheets of print media. Some inkjet print mechanisms carry an ink cartridge with a full supply of ink back and forth across the sheet. Other inkjet print mechanisms, known as “off-axis” systems, carry only a small ink supply with the printhead carriage, and store the main ink supply in a remotely-located reservoir. Typically, a flexible conduit or tubing is used to convey the ink from the off-axis main reservoir to the printhead cartridge. In multi-color cartridges, several printheads and reservoirs may be combined into a single unit.

Each inkjet pen has a printhead formed with small nozzles through which the ink drops are fired. Several ink ejection mechanisms are well-known in the art, including piezo-electric and thermal printhead technology. For example, two earlier thermal ink ejection mechanisms are described in U.S. Pat. Nos. 4,683,481 and 5,278,584, both assigned to the assignee of the present invention. In a thermal inkjet system, a barrier layer containing ink channels and vaporization chambers is typically located between a nozzle orifice plate and a substrate layer. This substrate layer typically contains heater elements, such as resistors, which are energized to heat ink within the vaporization chambers. Upon heating, an ink droplet is ejected from a nozzle associated with the energized resistor.

To print an image, the printhead is scanned back and forth across the print media, with the pen shooting drops of ink as it moves. By selectively energizing the resistors as the printhead moves across the sheet, the ink is expelled in a pattern on the print media to form a desired image (e.g., picture or text). The nozzles are typically arranged in one or more linear arrays. If more than one, the two linear arrays are typically located side-by-side on the printhead, parallel to one another, and perpendicular to the scanning direction.

One challenging problem encountered in the design of inkjet printing systems is the prevention of clogged print nozzles due to contaminants in the ink. Several long-term trends in inkjet technology contribute to the seriousness of this problem. First is the use of smaller, more closely-spaced nozzles to provide higher print resolution. Smaller, more numerous nozzles permit inkjet printers to approach photographic-quality output, but the smaller nozzles are more susceptible to clogging due to contaminants in the ink.

Second, to improve the clarity and contrast of the printed image, much research has been focused on improving the ink itself. To provide quicker, more waterfast printing with darker blacks and more vivid colors, pigment-based inks have been developed. These pigment-based inks have a higher solid content than the earlier dye-based inks, which results in a higher optical density. Pigment-based inks consist of finely-ground pigments suspended in a fluid, and are therefore susceptible to the formation of contaminant particles due to the aggregation of particles (flocculation).

Many different processes can contribute to the formation of flocculants (or “flocs”) in pigmented inks. Flocs can form due to contaminants in the ink, oxidation of the ink components, and material chemical incompatibilities. The ink may also contain pre-existing large particles which have escaped the filtering process.

One mechanism that has been shown to promote clogged nozzles is the storage of inkjet pens containing pigment-based ink for a length of time in a non-printing orientation. For example, instances have been documented in which pens with pigmented ink have been stored for several weeks on their sides, resulting in some of the pigment falling out of suspension, forming aggregates of gunk. When the pen is reoriented by installing it in a printer, the accumulated particles cascade downhill and into the ink feed channels. The particles find their way into the printhead, clogging the print nozzles.

To help prevent problems with flocculation and the settling of pigmented inks, previous efforts have focused on improving the ink by better milling of the pigment material, better dispersing of the pigment in the ink (by adding special chemicals to the ink), and better filtering of the ink. Attempts have also been made to control the orientation of inkjet pens during storage, shipment, and display, such as by packaging the pens in specially-shaped cartons. While these efforts have helped reduced the occurrence of clogged nozzles, they have not succeeded in eliminating the problem. There thus exists a need for apparatus and methods for preventing the clogging of inkjet printhead nozzles by contaminants.

### SUMMARY OF THE INVENTION

Embodiments of the invention comprise baffles located next to the input of the ink feed channel in an inkjet pen to capture and retain contaminant particles before the particles reach the printhead. Particles that may accumulate on interior surfaces of the pen when the pen is maintained in an non-printing orientation are thus prevented from cascading into the ink feed channel when the pen is reoriented for printing.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a perspective view of an exemplary inkjet pen, in which the >baffles of the present invention may be utilized.

FIG. 2 is partial enlarged view of the exemplary inkjet pen of FIG. 1, more clearly showing the printhead region of the pen.

FIG. 3 is a cross-section of an inkjet pen along line A—A of FIG. 2, showing interior structures of a typical “prior art” pen.

FIG. 4 is an enlarged view of area B—B of FIG. 3, illustrating how contaminants enter the ink feed slot and cause clogged nozzles in a typical “prior art” pen.

FIG. 5 is a cross-section of an inkjet pen according to an embodiment of the present invention.

FIG. 6 is an enlargement of area C—C of FIG. 5, illustrating how an embodiment of the present invention prevents contaminants from entering the ink feed slot leading to the printhead.

### DETAILED DESCRIPTION OF THE INVENTION

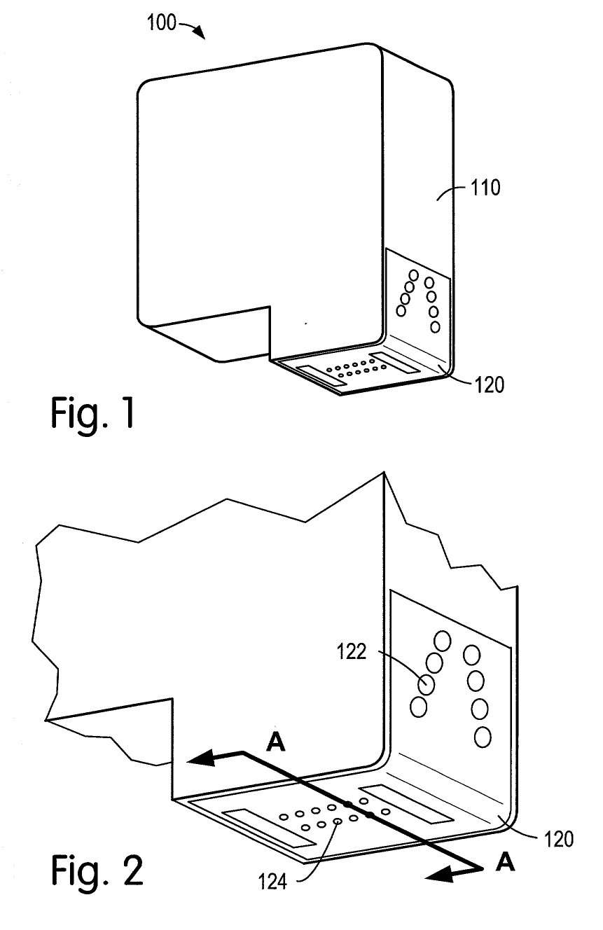

FIG. 1 is a perspective view of an exemplary inkjet pen 100 in which the baffles of the present invention may be utilized, and FIG. 2 is an enlarged partial view of the portion of the pen including the ink nozzles and electrical interfaces. The exemplary pen illustrated is a single-color pen, such as would typically be used for black pigmented ink. The inkjet pen 100 comprises a main pen body 110 configured to hold a supply of ink, and a printhead portion including a flexible circuit 120. The flexible circuit 120 includes electrical contacts 122 for receiving print information and for transmitting status information. Formed in the flexible circuit are rows of nozzle openings 124.

The exemplary inkjet pen 100 may also include other components, such as keying and latching features, and memory devices to store printing parameters and information about the ink (not shown). Although the exemplary inkjet pen 100 is shown as a single-color pen, the present invention is also applicable to multicolor pens, and to pens with other form factors and external characteristics than those shown in FIGS. 1 & 2.

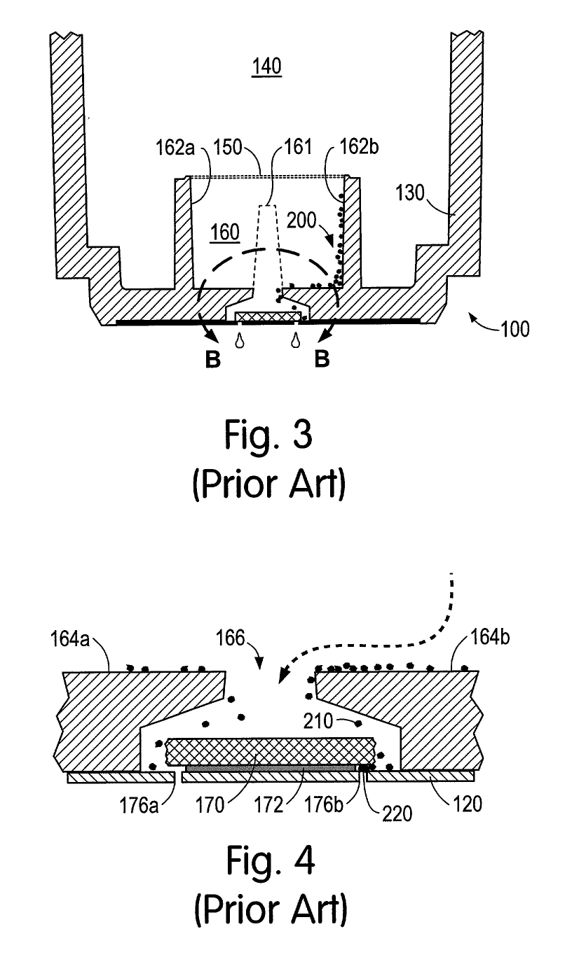

FIG. 3 is a simplified cross-sectional view of the exemplary inkjet pen along line A—A of FIG. 2, showing the interior structure of a typical “prior art” pen. An outer pen body frame 130 encloses a main ink reservoir 140, which may be filled with an absorbent foam or other material to retain ink (for clarity, the foam or other material is not shown). An ink filter 150 is typically provided that serves to remove most particulates from the ink before the ink reaches the printhead. A small post-filter ink chamber 160 typically holds “free” ink (e.g., freely-flowing ink, without a foam material) and acts as a standpipe for warehousing air which may accumulate above the printhead; it may include a fluid connection 161 with a larger standpipe which provides for greater air accumulation (again for clarity, the ink and air in chamber 160 is not shown).

As better shown in FIG. 4, the exemplary prior art inkjet pen includes a printhead die 170 and a barrier layer 172 affixed to the flexible circuit 120; with nozzle openings 176a, 176b formed in the flexible circuit. Ink from the small post-filter ink chamber 160 is fed to the printhead die 170 through an ink feed channel 166, entering the channel from the chamber 160 and exiting near the printhead 170. The channel is typically an elongated slot approximately the length of the printhead die 170; the slot is seen in cross-section in FIG. 4.

Within the small ink chamber 160, particles 200 may settle out of the ink due to “flocculation” or other mechanisms. These particles will typically settle to the bottom of the ink, accumulating on whichever interior surface of the chamber is lowermost. By way of illustration, FIG. 3 depicts a situation wherein a pen has been stored resting on its right side for a period of time, such that aggregated particles 200 have accumulated on interior surface 162b. Matching surface 162a, in contrast, remains relatively free of particles. Such a situation may occur, for example, when pens are stored on their sides during shipping and storage. When the pen is subsequently reoriented by installing in the printer, the accumulated particles on surface 162b may cascade downhill across surface 164b and into the ink feed channel 166, as indicated by the dashed arrow. As shown in FIG. 4, particles such as 210 may pass through the ink feed channel 166 and subsequently form clogs, such as shown at 220.

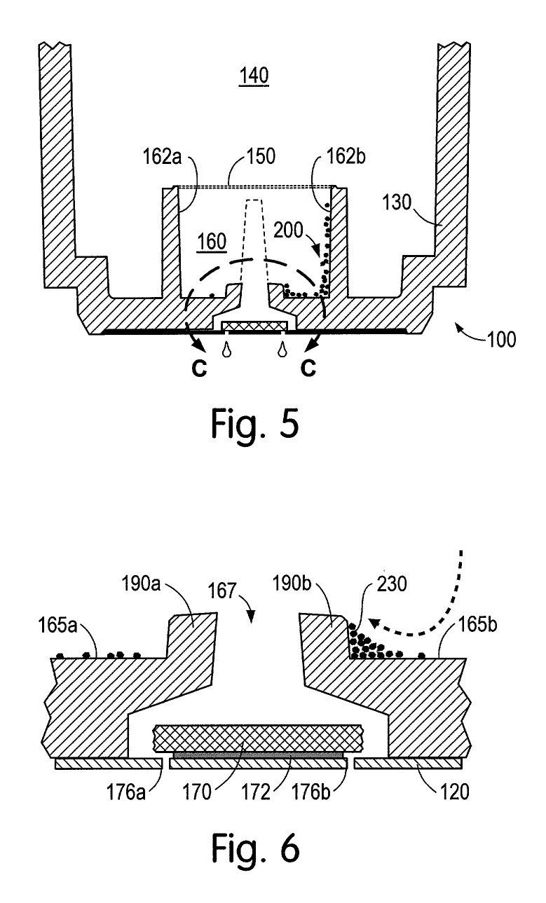

FIG. 5 is a simplified cross-sectional view of an exemplary inkjet pen incorporating the baffles of the present invention. As in the prior art pen, an outer pen body frame 130 encloses a main ink reservoir 140, which may be filled with a foam or other material (not shown) to retain ink. An ink filter 150 is typically provided that serves to remove most particulates from the ink before the ink reaches the printhead. FIG. 5 illustrates a comparable situation to FIG. 3, wherein the pen has rested on its right side for a period of time, such as for shipping or storage, resulting in the accumulation of aggregate particles on surface 162b.

FIG. 6 is an enlargement of area C—C of FIG. 5, illustrating how an embodiment of the baffles 190a, 190b of the present invention prevent contaminants from entering the ink feed slot 167 leading to the printhead. The baffles 190a, 190b are seen in cross-section in FIGS. 5 & 6, and flank the length of the elongated ink feed slot 167. After the pen is reoriented by installation into the printer, the particles cascade down surface 162b, but are prevented from entering the ink feed channel 167 by baffle 190b. The particles instead accumulate behind the baffle, as shown at 230. Matching baffle 190a would likewise serve to prevent particles from cascading down surface 162a into the ink feed channel 167.

It may also be observed that the baffles 190a, 190b will serve to prevent particles that settle on normally horizontal surfaces 165a, 165b from moving into the ink feed channel 166. In addition to providing protection against particles forming in pigmented inks, the baffles of the present invention are also effective against other contaminants, such as, for example, debris particles resulting from the ink container manufacturing process. The baffles 190a, 190b also serve to stiffen the pen body in the vicinity of the printhead.

While a substantially square cross-sectional shape is shown for the exemplary embodiment of the baffles 190a, 190b in FIG. 6, other shapes may also be effective. To prevent particles 230 from entering the ink feed channel 167, the baffles should preferably protrude above surrounding surfaces 165a and 165b. If surfaces 165a and 165b are viewed as the “floor” of small chamber 160 when the pen is oriented for printing, than the baffles should preferably rise above the “floor”.

While the present invention has been particularly shown and described with reference to the foregoing preferred and alternative embodiments, those skilled in the art will understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. In an inkjet pen having a printhead affixed to a pen body, the pen body enclosing an ink reservoir and having an ink feed channel to convey ink from the reservoir to the printhead, the ink feed channel having an entrance end and an exit end, the exit end adjacent to the printhead:
a baffle to capture and retain particulates in the ink, the baffle comprising a raised protrusion flanking the ink channel entrance end.

2. The baffle to capture and retain particulates of claim 1, further comprising an inkjet pen body and wherein the baffle is integrally formed with pen body.

3. The baffle to capture and retain particulates of claim 2, wherein the pen body encloses an ink reservoir containing an absorbent foam material.

4. The baffle to capture and retain particulates of claim 3, further comprising an ink filter in fluid communication with the ink reservoir.

5. The baffle to capture and retain particulates of claim 4, further comprising an ink chamber fluidically interposed between the ink filter and the ink channel entrance end.

6. The baffle to capture and retain particulates of claim 1, wherein the ink feed channel comprises an elongated slot formed in the pen body, the slot having two opposing long sides, the baffle comprising protuberances flanking each of the long sides.

7. In an inkjet pen having a printhead affixed to a pen body, the pen body enclosing an ink reservoir and having an ink feed channel to convey ink from the reservoir to the printhead, the ink feed channel having an entrance end and an exit end, the exit end adjacent to the printhead:
baffle means flanking the ink feed channel entrance end to capture and retain particulates in the ink.

8. An inkjet pen, comprising:
a printhead affixed to a pen body, the pen body enclosing an ink reservoir and having an ink feed channel to convey ink from the reservoir to the printhead, the ink feed channel having an input end and an output end, the output end adjacent to the printhead; and
a baffle to capture and retain particulates in the ink, the baffle forming a raised protrusion flanking the ink channel input end.

9. The inkjet pen of claim 8, wherein the baffle is integrally formed with pen body.

10. The inkjet pen of claim 9, wherein the pen body encloses an ink reservoir containing an absorbent foam material.

11. The inkjet pen of claim 10, further comprising an ink filter in fluid communication with the ink reservoir.

12. The inkjet pen of claim 10, further comprising an ink chamber fluidically interposed between the ink filter and the ink channel entrance end.

13. The inkjet pen of claim 8, wherein the ink feed channel comprises an elongated slot formed in the pen body, the slot having two opposing long sides, the baffle comprising protrusions flanking each of the long sides.

14. An inkjet pen, comprising:
printhead means affixed to a pen body, the pen body enclosing an ink reservoir and having an ink feed channel to convey ink from the reservoir to the printhead means, the ink feed channel having an input end and an output end, the output end adjacent to the printhead means:
protrusion means to capture and retain particulates in the ink flanking the ink channel input end.

15. An inkjet pen, comprising:
a printhead affixed to a pen body;
the pen body enclosing an ink reservoir, the reservoir providing ink to an ink filter;
a chamber for receiving ink from the ink filter, the chamber having a floor;
an ink feed channel forming an opening in the chamber floor and providing ink to the printhead;
the portion of the chamber floor adjacent to the ink feed channel opening extending above at least a portion of the remaining chamber floor.

16. The inkjet pen of claim 15, wherein the ink feed channel comprises an elongated slot formed in the pen body, the slot having two opposing long sides, the baffle comprising protrusions flanking each of the long sides.

17. The inkjet pen of claim 15, wherein the ink reservoir further comprises foam material for absorbing ink.

18. The inkjet pen of claim 15, wherein the ink reservoir contains pigmented ink.

19. An inkjet pen, comprising:
a printhead affixed to a pen body, the pen body enclosing an ink reservoir, the reservoir containing an ink absorbent material;
an ink filter receiving ink from the reservoir;
an ink chamber receiving ink from the ink filter;
an ink feed channel to convey ink from the ink chamber to the printhead, the ink feed channel comprising an elongate slot and having an input end and an output end, the output end adjacent to the printhead; and
a baffle integrally formed with the pen body to capture and retain particulates in the ink, the baffle forming a raised protrusion flanking the ink channel input end.

20. A method of preventing particulate contaminants, which settle out of pigmented ink when an inkjet pen is stored in an orientation other than its normal printing orientation and accumulate on interior surfaces of the pen, from reaching the printhead of an inkjet pen; the inkjet pen having an ink feed channel providing ink to a printhead; comprising:
capturing the contaminants behind baffle structures positioned adjacent to the ink feed channel when the pen is reoriented to its normal printing orientation.
